(19) United States
(12) Patent Application Publication
(10) Pub. No.: US 2021/0264515 A1
(43) Pub. Date: Aug. 26, 2021

(54) System and method for facilitating collateralized term transactions

(71) Applicants: Ari Pine, Long Beach, NY (US); Paul Murray Sacks, New York, NY (US)

(72) Inventors: Ari Pine, Long Beach, NY (US); Paul Murray Sacks, New York, NY (US)

(21) Appl. No.: 16/799,760

(22) Filed: Feb. 24, 2020

(51) Int. Cl. G06Q 40/04; G06Q 40/02

(52) U.S. Cl. CPC G06Q 40/04; G06Q 40/025

(57) ABSTRACT

A system and method for managing collateralized term transactions between two counterparties, employed by a third party, utilizing a novel margining process integrating escrow accounts and regularly rebalancing the notional amount of the transaction. The system and method allows far wider applicability to different forms of collateral and allows unfamiliar or lesser credit-worthy counterparties to transact.

### BACKGROUND

The financial system provides a number of mechanisms for parties to obtain financing or swap assets. A principal consideration in all such transactions is the reliability of one's counterparty to fulfill all of the obligations specified in the transaction. This is termed credit risk. One method of addressing credit risk is to engage in collateralized transactions, such as a repurchase agreement or an FX basis swap.

The repurchase agreement (RP or repo) in its simplest form, functions as a collateralized loan where one party borrows currency and posts extremely high-quality assets, e.g., US Treasury securities or AAA mortgages. The mechanism involves an exchange of collateral for currency where the amount of collateral tends to be in slight excess to the notional amount of the loan.

Differing jurisdictions (and contracts) specify the legal definitions slightly differently in terms of whether the transaction is dealt with as matched outright sale and forward purchase, as a lien, or as a loan. The key to the transaction is allowing a counterparty to take fast and efficient control of the collateral in the event of a default. Generally, the mechanics of the transaction rebalance on a daily basis to ensure that the collateral value matches the loan value. This is a highly successful framework because the market is oriented around a few credit worthy counterparties (dealers or wholesalers), non-dealer participants engage the market as dealer clients, and the collateral involved is of sufficiently high quality and low volatility that its value is not expected to change drastically over the period of rebalancing (overnight).

As can be inferred from the description above, it is advantageous to be a dealer as there is the ability to participate in the wholesale market for both information and market advantage. In the cryptocurrency market there is a more decisive advantage. The current state of the market when borrowing or lending cryptocurrency—whether thought of as a repo or as an FX basis swap—heavily favors the dealer. Customer relationships are different in the crypto market as clients do not typically leave long term deposits with dealers (market makers) nor do they rely on crypto market makers as prime brokers to handle clearing and settlement. Therefore, dealers require high levels of earnest money from clients. It is not unusual for a market maker to require margin in excess of 25%-50% of the value of the transaction and to post nothing to the client in return. This is clearly unfavorable to the client and, in traditional capital markets, the dealer community is actually considered to be a risky counterparty (vs equivalently rated credits). In the crypto market with very little, if any, disclosure by market makers, clients are running huge risks transacting in crypto borrow. In the event a market maker defaults, clients look at transaction losses not only for the notional amount of the trade but for the additional 50% margin that was posted.

Over the past few decades, Tri-Party Repo has gained market share. Repo remains a transaction between two counterparties but in a Tri-Party Repo, the custodian handles much or all of the administrative burden. This makes the whole process safer and cheaper because in the fixed income world, which is the main volume of repo transactions, there are few custodian banks and there has developed a single tri-party clearing bank. The primary benefits are reduced settlement risk and cheaper administration. The fundamental process and credit risk remain in place and still favor/require the same assumptions of narrow participation by highly rated participants with familiarity and assets with low volatility.

### BRIEF SUMMARY OF INVENTION AND ADVANTAGES

We have invented a new method of administering a collateralized term transaction that combines the features of a tri-party repo, an escrow/margin system, and risk management principles. The method provides a way for any two parties to engage in a collateralized term transaction in such a way that significantly reduces settlement and credit risk. It achieves this by utilizing a trusted third party, the Tri-Party Administrator (TPA), and requiring the parties involved in the transaction to post margin (earnest money) with the TPA. The TPA follows a protocol to move margin between parties according to market movements that includes intra-day action, to receive and give back margin according to requirements, and to enter into default procedures in case of such an event.

Such improvements in the marketplace for collateralized term transactions, e.g., repo, have the following advantages
Posting margin allows a risk buffer that:
   Enables participants to enter into transactions without needing to understand the credit risk of their counterparty
   Enables collateral to be a volatile asset (as compared with US Treasury or other fixed income assets) such as cryptocurrency or equities
   Can be adjusted at different levels to provide protection adapting to different assets or market conditions
   Can include non-linear assets, e.g., options, to further reduce market risks
Rebalancing allows participants to enter into agreements with a much wider array of assets for essentially any length of time.
Collecting margin from both parties, as opposed to just one party, which is currently common practice, reduces the risk of both individual and systemic default and allows both parties to proceed with greater confidence
The TPA is obligated and incentivized to ensure proper protocol is followed
The minimization of credit risk eliminates the need for the marketplace to place a premium on a wholesale-retail type market and opens the market for all participants to transact directly with others: a peer-to-peer or many-to-many marketplace.
Intra-day rebalancing of collateral provides further safety
Having a contained escrow not only gives a cushion when asset prices move but is cheaper and faster for the counterparties as they are internal transactions and don't require payment system fees, e.g., wire fees.

### BRIEF DESCRIPTION OF THE DRAWINGS

FIG. 1 Desirable Embodiment

FIG. 2 Initiation Process

FIG. 3 Maintenance Process

FIG. 4 Rebalancing Process

FIG. 5 Default Process

FIG. 6 Completion Process

### DEFINITIONS

Cryptocurrency Repo: a transaction between two parties where party A lends a cryptocurrency to party B for a specified (or open) term in exchange for an interest payment. Party B sends an equivalent, based on market pricing, amount of another currency such as USD, EUR, or another cryptocurrency. For the purpose of protection under default circumstances, the “loan” is effected as a spot transaction of anchor for pricing currency matched with a deferred reverse transaction of pricing for anchor currency. In relation to capital markets, a cryptocurrency repo resembles an FX Basis Swap more than a RP, technically, but this is a semantic difference.
Anchor Currency: in a repo, the currency (or asset) whose amount is kept constant throughout the term of the transaction.
Pricing Currency: in a repo, the currency (or asset) that is not the Anchor Currency and is used for collateralizing the exchange between Party A & B, i.e., each party at inception has equal value assets with respect to the transaction in order to protect both sides in the event of default.
Margin Currency: over the life of the transaction, value may move between the two parties in order to rebalance the collateralization. The value is moved in denomination of margin currency and the margin currency is generally the pricing currency.
Default: When a party fails to fulfill the terms of the contract specified for that party. In a cryptocurrency repo, this may be a failure to deliver the initial collateral, failure to deliver interest payments, failure to post appropriate margin during the term of the trade as specified in the contract, or failure to deliver the terminal collateral amount due.
Interest Currency: the currency that interest payments in a repo are denominated in. Generally, the Interest Currency is the Anchor Currency.

### DETAILED DESCRIPTION AND IMPLEMENTATION

In accordance with at least one embodiment of the invention wherein the transaction administered by the TPA is a cryptocurrency Repo:

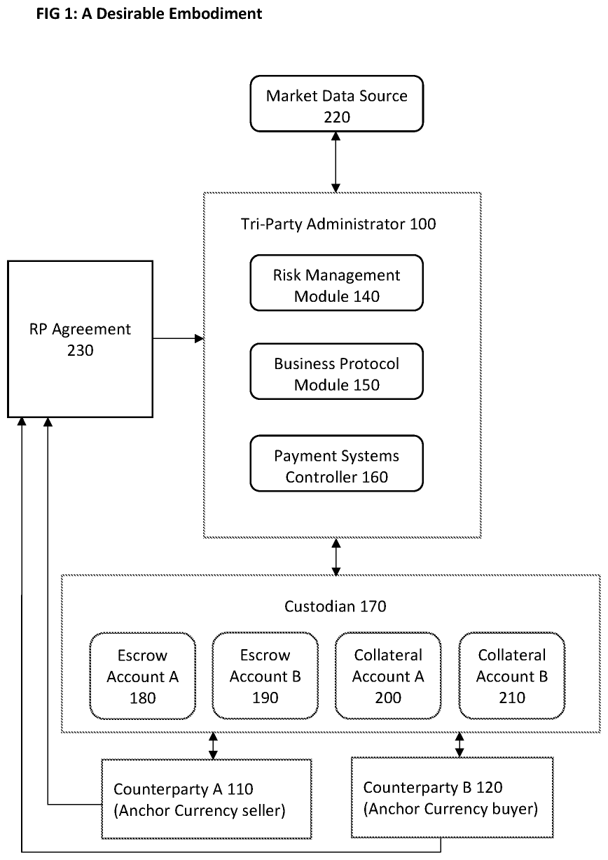

### A Desirable Embodiment (FIG. 1):

A TPA consists of three major components: the Risk Management Module (“RMM”) 140, the Business Protocol Module (“BPM”) 150, and the Payment Systems Controller (“PSC”) 160. In order to perform the functions of the TPA, it requires a Market Data Source 220, an RP agreement (“RPA”) 230 defining the terms of the transaction to be administered, and a Custodian 170 that has the capability of storing, reporting on, and moving all relevant assets internally and externally.

Counterparty A 110 is in this embodiment the Anchor Currency seller in the cryptocurrency repo (RP or repo) and Counterparty B 120 is the Anchor Currency buyer agree to terms that constitute an RPA 230. The RP terms include, but are not limited to, size, anchor currency, pricing currency, interest rate and currency, contract date, purchase date, repurchase date, margin requirement, margin thresholds that trigger default, etc. After agreeing to terms they seek out a TPA 100.

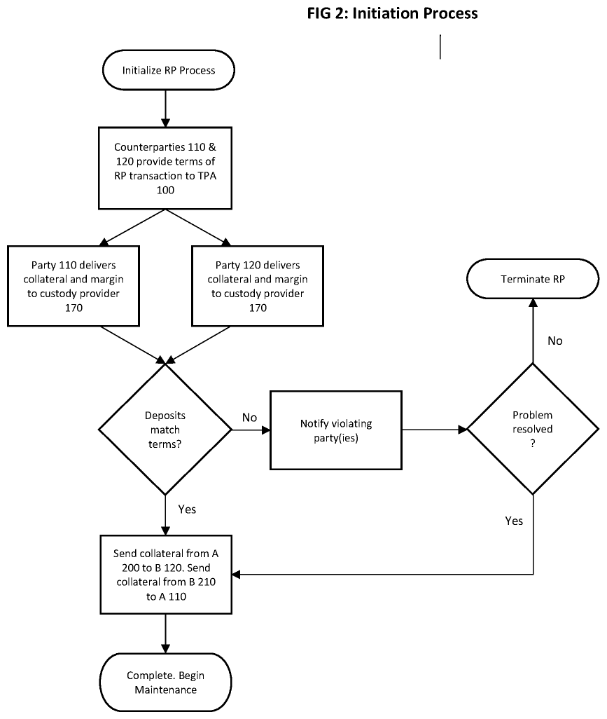

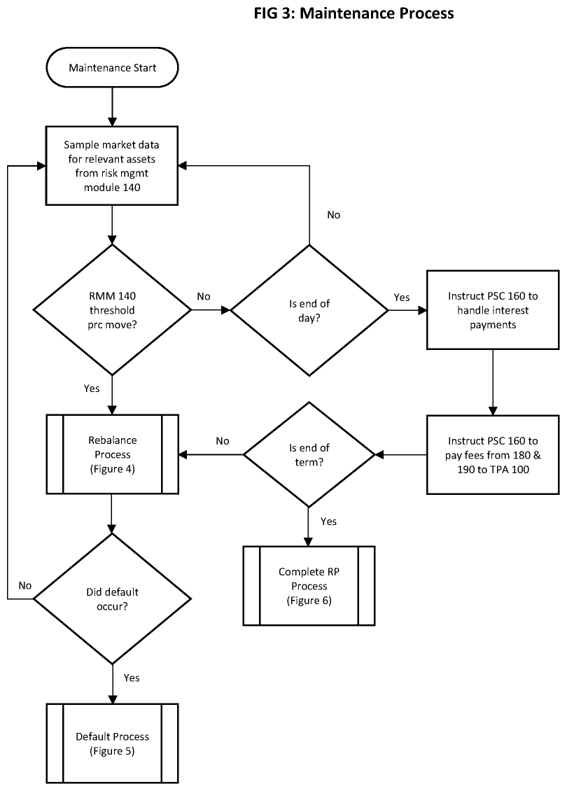

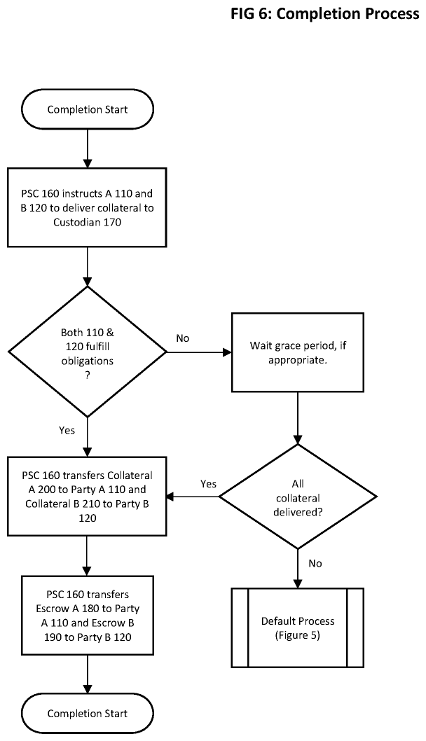

The BPM 150 is a set of processes that can be done manually or with a computer system that consists of reference to RPA 230, the ability to interface with the RMM 140 and PSC 160, and the capacity to perform the processes described in FIGS. 1-7. The BPM 150 processes include the Initiation of the RP (FIG. 2), the Maintenance of the RP (FIG. 3), and the Completion of the RP (FIG. 6). They, along with various subroutines, are described below.

In the current embodiment, the RMM 140 consists of an interface to the Market Data Source 220 obtaining data on pricing for the Anchor/Pricing currency pair, a memory, and a comparator. At appropriate intervals, which may be specified in the RPA 230, the RMM will obtain pricing data from the Market Data Source 220 which will then be compared to the price at which the last prior rebalancing occurred. Based on a threshold level defined by the RPA 230 or by the TPA, it will determine whether the price movement exceeded the threshold level and communicate with the BPM 150.

PSC 160 consists of an interface to the Custodian 170, a memory that includes reference to the RPA 230, appropriate security permissions, and appropriate legal authority to effect currency movements between accounts of Counterparty A 110 and Counterparty B 120 relevant to the specified RP Agreement 230. The interface of the PSC 160 should allow it to be able to move currency between Escrow Account A 180 and Escrow Account B 190, determine the amount and denomination of currency in Accounts 180, 190, 200, 210, move Collateral 200 to Counterparty B and Collateral 210 to counterparty A. In the event of default, it needs to be able to move currency from both Escrow Accounts 180 & 190 to the non-defaulting party. If the TPA is handling interest payments, then additional permissions to move interest currency from the borrower (generally Counterparty B 120 the Anchor currency buyer) to the lender to accounts specified in the RPA 230.

### Initiation Process (FIG. 2):

As shown in FIG. 2, Counterparty A 110 and Counterparty B 120 provide the terms to the RPA 230 to the TPA 100. Per the terms of the RP, Counterparty A 110 delivers collateral to Custodian 170 into Collateral Account A 200 and margin to Escrow A 180. Similarly, Counterparty B 120 delivers Collateral B 210 and Escrow B 190 to the Custodian 170. If all the deposits match the terms of the RPA 230 then the TPA 100 sends Collateral A 200 to Counterparty B 120 and sends Collateral B 210 to Counterparty A 110. Then the RP is initiated, and the maintenance phase begins. If, however, the deposits do not match the terms of the RPA 230 then the TPA 100 notifies the violating party (or parties). If the error is corrected in a timely manner, then the TPA 100 will move on to sending the collaterals as just described. If the error is not corrected within a specified grace period, then the RP is Terminated.

### Maintenance Process (FIG. 3):

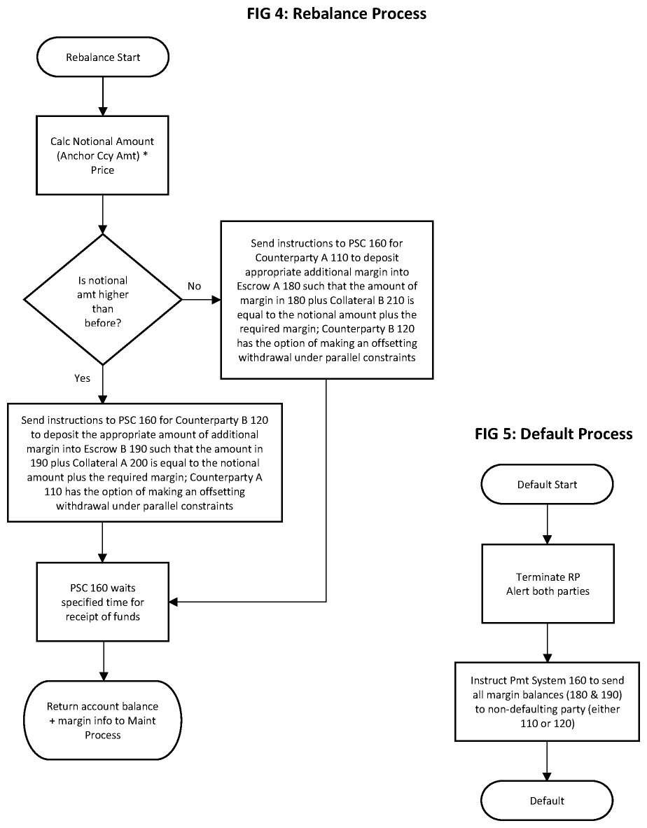

As shown in FIG. 3, the RMM 140 samples the relevant asset price (in this case the price of the Anchor Currency as defined by the Pricing Currency). It then directs the data to BPM 150. If the new price of the Anchor Currency, as compared to the price of the Anchor Currency during the previous sampling, has changed enough then a Rebalance Process is triggered (see FIG. 4 and described below). If the RMM 140 informs the BPM 150 that a Rebalance is not warranted, the BPM must determine whether it is currently the end of the day (a time each day, as defined in the RPA 230). If it is the end of the day then the BPM 150 determines whether it is the end of the (RP) contract. If it is the end, then the BPM 150 proceed to the RP Completion Process (see FIG. 6). If it is the end of the day, but not the end of the contract, thes the BPM 150 proceeds with a Rebalance (see FIG. 4). If the price change does not warrant a Rebalance, and if it is also not then end of the day, then no Rebalance occurs and the process repeats.

Upon returning from the Rebalance Process, the BPM 150 will determine whether either party is in default, i.e., having a sufficient balance in their respective Escrow Accounts 180 & 190. If neither party is in default, then the cycle repeats. If there is a default condition, then BPM 150 initiates the Default Process as specified in FIG. 5 and below.

If it is End of Day, as defined in RPA 230 or TPA 100, the BPM will first, instruct the PSC 160 to effect the interest payment as defined in RPA 230. Depending on prevailing market conditions, this may be from party B 120 to party A 110 or the other way around. The respective Escrow Accounts 180 & 190 will be used as appropriate source and destination of funds. Second, the BPM will instruct PSC 160 to pay fees to TPA 100 in line with negotiated fees using funds from both Escrow Accounts 180 & 190.

If the transaction is at the end of its term BPM 150 begins Complete RP Process. Otherwise, the Rebalance Process is begun.

### Rebalance Process (FIG. 4):

If a Rebalance is warranted, then, as shown in FIG. 4, the BPM 150 will send instructions to the PSC 160 to notify counterparties of new escrow balance requirements. Each party's total balance—the sum of the collateral delivered to them at initiation plus their current respective escrow account—must have a value equal to or greater than the notional amount of the transaction at current market price plus the required margin amount. Should a party's total balance exceed the required amount, that party has the option to withdraw the excess funds from their escrow account. Part of the process is to wait an appropriate amount of time, specified in the RPA 230 or TPA 100, and which may include a grace period. At the conclusion of the Rebalance the updated account balance information and the calculated requirements for both parties are returned to the Maintenance Process.

### Default Process (FIG. 5):

The Default Process begins by announcing formally to both parties via a preferred communication medium as specified in RPA 230 that the (Repo) transaction is terminated. BPM 150 will instruct PSC 160 to send both Escrow Accounts 180 & 190 to the non-defaulting party.

### Completion Process (FIG. 6):

When the end of the contract is reached (repurchase date) then both counterparties are to return collateral delivered to them back to the Custodian 170. That is, Counterparty A 110 is to return Collateral B 210 to the Custodian 170, and Counterparty B 120 is to return Collateral A 200 to the Custodian 170. If either party fails to deliver the collateral back by a time specified in the RPA 230 (or a time specified by the TPA 100) then a grace period may be granted. The grace period may be specified in the RPA 230 or by the TPA 100. If at the end of the grace period, the PSC 160 does not see the return of a collateral then the party that has not returned the collateral is in default which causes the Default Process to begin. The Default Process, seen in FIG. 5, is described above. If either at the end of the contract or at the end of the grace period the PSC 160 sees both collaterals have been returned to the Custodian 170 then the PSC 160 will return the collaterals to the counterparties, meaning Collateral A 200 will be returned to Counterparty A 110 (the Anchor Currency) and Collateral B 210 (the Pricing Currency) will be returned to Counterparty B 120. Coincident to the returning of the collaterals the PSC 160 returns any remaining margin to the respective party, meaning any amount of margin left in Escrow A 180 is returned to Counterparty A 110 and any amount of margin left in Escrow B 190 is returned to Counterparty B 120. The Completion Process, and thus the (RP) transaction, is complete.

### DRAWINGS: REFERENCE NUMBERS

100 Tri-party Administrator (TPA)
110 Counterparty A; seller of Anchor Asset
120 Counterparty B; seller of Pricing Asset
140 Risk Management Module (RMM)
150 Business Protocol Module (BPM)
160 Payment Systems Controller (PSC)
170 Custodian
180 Escrow A, margin posted by Counterparty A
190 Escrow B, margin posted by Counterparty B
200 Collateral A, collateral posted by Counterparty A
210 Collateral B, collateral posted by Counterparty B
220 Market Data Source
230 Repo Agreement (RPA)

### ALTERNATIVE EMBODIMENTS

The above is not the only embodiment of the invention. Alternatively:
The current embodiment references cryptocurrency repo specifically, but our invention is designed for any collateralized term transaction. There is no reason that the invention is limited to any particular asset; it is useful for currency, debt, equity, and commodity transactions. It is easily adapted, for example, to other repo, FX Basis swaps, asset swaps, commodity swaps, and securities lending.
The TPA can also be the custodian
Counterparties can be matched by the TPA, on some sort of platform or other means
Interest payments can be made all at once in the beginning, daily, all at once all at the end, or some other uniform or non-uniform interval
The risk management module can be expanded in scope to incorporate various traditional risk measures such as:
   Option pricing
   Lookback volatility measures
   Credit checks; credit info service providers
   Other external data that would inform a credit or market-based decision
The processes in the described embodiment are intended to be automated but the process or sub-processes can be automated, partially automated, or manual. For instance, notifications may be by email, phone, fax, or message service. Similarly, risk management can be an automated, semi-automated, or manual process.
Contracts can be open/rolling. An example of a rolling contract is an overnight transaction where both parties agree to extend or roll the transaction into another overnight transaction of the same assets but potentially different sizes and with other potentially differing parameters.
Grace periods can vary, including having none, i.e., zero time.
Although not discussed within the description of the embodiment above, the Tri-Party Administrator is expected to earn a fee for its role. Payment to the TPA can consist of an origination fee and may also include an ongoing fee based on time or notional amount which can occur daily, for example during the rebalancing process, or all at the beginning of the transaction, or all at the end of the transaction.
The TPA can participate in the default process in a variety of ways. One way is to not engage, and allow the non-defaulting party take control of the collateral and margins and the decision of whether or how to liquidate. Another way would be for the TPA to facilitate in the liquidation, assisting the non-defaulting party in converting the collateral and margins into the preferred form.
Both parties can take possession of opposing counterparty's collateral, or either counterparty has the option to leave it with the custodian.
Both parties can post the same, or symmetrical, margin (as measured in percentage of collateral terms) or they can post different amounts of margin.
The margin can be in the form of Party A's collateral, Party B's collateral, or a third form
The methods and systems apply to sell/buy back agreements just as they apply to repurchase agreements
Rebalancing can take place at a variety of intervals. This can be based on the particular assets in the transaction (i.e. their volatility, their liquidity, etc.). It can also be variable over the term. It can react dynamically to changing market conditions.
The majority of, but not all, current RP transactions are overnight. Our system works well for altering or extending the RP transactions to any length of time, including but not limited to, any number of days, any number of weeks, any number of months, or longer.
Any process involved in the initiation, maintenance or completion of the RP can be manual, semi-automated, or automated.
The above system and method that is handled using smart contract technology on a blockchain or other cryptographic solution thereby enabling “trustless” transactions.
An embodiment may have one or both parties grant the TPA an ability to source funds for Rebalance and Completion from an external bank, custodian, wallet, or other funding source.

We claim:

1. A method for managing a collateralized term transaction by a tri-party administrator comprising:
a) means for the tri-party administrator to hold and control escrow, functioning as security against performance, from the relevant counterparties,
b) means for the tri-party administrator to exchange collateral between counterparties,
c) repo agreement specifying the terms of the transaction,
d) means for the tri-party administrator to communicate with counterparties,
e) means for tri-party administrator to verify balances, exchanges of collateral, and other measures of counterparty performance,
f) means to monitor external conditions, value collaterals, and value escrows in a risk management module,
g) means to execute default procedure comprising the means of a), b), and f),
h) tri-party administrator communicating instructions to and verifying performance of counterparties for the initiation and conclusion of the transaction as specified in the Repo Agreement,
i) tri-party administrator communicating instructions to and verifying performance of counterparties for rebalancing collateral and escrow value determined by the risk management module and as specified in the repo agreement,
j) tri-party administrator executes default procedure as specified in the repo agreement if one or more of the counterparties fails to perform as instructed, whereby each counterparty mitigates credit risk in said transaction independent of ability to determine creditworthiness.

2. The method of claim 1 wherein the transaction is a collateralized loan or swap.

3. A system for managing a collateralized term transaction by a tri-party administrator comprising:
a) means for the tri-party administrator to hold and control escrow, functioning as security against performance, from the relevant counterparties,
b) means for the tri-party administrator to exchange collateral between counterparties,
c) repo agreement specifying the terms of the transaction,
d) means for the tri-party administrator to communicate with counterparties,
e) means for tri-party administrator to verify balances, exchanges of collateral, and other measures of counterparty performance,
f) means to monitor external conditions, value collaterals, and value escrows in a risk management module,
g) means to execute default procedure comprising the means of a), b), and f),
h) tri-party administrator communicating instructions to and verifying performance of counterparties for the initiation and conclusion of the transaction as specified in the repo agreement,
i) tri-party administrator communicating instructions and verifying performance for rebalancing collateral and escrow value determined by the risk management module and as specified in the Repo Agreement,
j) tri-party administrator executes default procedure as specified in the repo agreement if one or more of the counterparties fails to perform as instructed, whereby each counterparty mitigates credit risk in said transaction independent of ability to determine creditworthiness.

4. The system of claim 3 wherein the transaction is a collateralized loan or swap.
